(19) United States
(12) Patent Application Publication
(10) Pub. No.: US 2003/0076676 A1
(43) Pub. Date: Apr. 24, 2003

(54) Diver's mask and lighting assembly

(76) Inventors: Michael D. Gordon, Santa Clarita, CA (US); Peter F. Readey, Hermosa Beach, CA (US)

Correspondence Address: W. Edward Johansen, 11661 San Vicente Boulevard, Los Angeles, CA, 90049, US

(21) Appl. No.: 09/817,007

(22) Filed: Mar. 22, 2001

(51) Int. Cl. F21L 4/00

(52) U.S. Cl. 362/185; 362/103; 362/158

(57) ABSTRACT

A combination underwater diver's mask and lighting assembly includes a faceplate, a frame, a lighting assembly and electrical source. The faceplate is inserted in the frame. The frame has a top, a first side and a second side. The lighting assembly is mechanically coupled to the frame. The lighting assembly includes a plurality of light emitting diode and a mounting strip. Each light emitting diode is mechanically coupled to the mounting strip. The mounting strip is mechanically coupled to the top of the frame. The electrical source electrically coupled to the light emitting diodes of the lighting assembly.

### BACKGROUND OF THE INVENTION

This invention relates to a combination mask and lighting assembly for use by an underwater diver.

U.S. Pat. No. 5,767,932 teaches an underwater diver's combination mask and lighting assembly which includes a face-plate, a frame, an interface, a lighting assembly and an electrical source. The face-plate is inserted in the frame which has a first side and a second side. The interface is inserted between the frame and the face of the underwater diver. The lighting assembly is mechanically coupled to the frame. The electrical source is electrically coupled to the lighting assembly.

U.S. Pat. No. 5,622,422 teaches a scuba or snorkel device with a circuit which will turn on a light emitting diode one or more times over a timed flash interval but will respond to a further closure of the switch during the flash interval. A circuit is prevents response to such switch if two probes do not sense that the probe is in water. The circuit preferably will time a longer interval and turn on the light if the motion responsive switch is not actuated over the longer interval.

U.S. Pat. No. 5,070,437 teaches a submersible light which includes a generally cylindrical housing body having a closed end and an open end. A light emitting diode and a plurality of batteries are provided in the body and an end cap for the open end actuates the light by flexing a lead of the light emitting diode into engagement with the batteries. A clamp ring is provided on the outside of the cylindrical housing body under which a line can slip for snap-on attachment of the light to a fishing line and the like.

U.S. Pat. No. 4,870,550 teaches a waterproof flashlight. The flashlight includes a connector and a watertight seal. The waterproof flashlight is commercially available from Underwater Kinetics in San Marcos, Calif. The waterproof flashlight includes batteries and a bulb and has been found to have a specific gravity of greater than one so as to sink when it is released in water. Straps connect the waterproof flashlight to the strap of a diver's mask. The light of the underwater flashlight is placed immediately adjacent to the head of the underwater diver. The underwater flashlight includes no support element.

U.S. Pat. No. 5,359,371 teaches an underwater diver's mask. The underwater diver's mask includes a faceplate, a frame and an interface. The faceplate is inserted in the frame. The interface is inserted between the frame and the face of the underwater diver.

There have been a variety of different illumination devices. These devices provide light for underwater divers and swimmers. U.S. Pat. No. 4,429,350, U.S. Pat. No. 4,638,410, U.S. Pat. No. 4,734,834 and U.S. Pat. No. 4,817,212 teach many of these illumination devices.

Heretofore there have also been a variety of different flashlight headbands and retainers. U.S. Pat. No. 5,053,932, U.S. Pat. No. 5,034,862, U.S. Pat. No. 4,970,631, U.S. Pat. No. 4,887,194, U.S. Pat. No. 4,797,793, U.S. Pat. No. 4,729,499, U.S. Pat. No. 4,718,126, U.S. Pat. No. 4,360,930 and U.S. Pat. No. 3,249,271 teach many of these flashlight headbands and retainers.

None of the devices which the above mentioned prior art patents teach provides a lightweight, inexpensive, streamlined apparatus for holding a flashlight adjacent to the side of the head of an underwater diver in order to free his the hands for other purposes, while still providing underwater illumination. None of apparatuses which the above mentioned patents teach provide an apparatus which is designed for releasable connection to head gear worn by underwater divers and which include an element for providing combined support and orientation to a flashlight and which also includes a combined support and orientation element which has a specific gravity of less than one, thereby providing floatation to the apparatus and to any article which is carried by the apparatus, as well as support and orientation to a flashlight. None of apparatuses which the above mentioned prior art teaches provides such an apparatus which includes a system for releasably connecting it to the head gear of an underwater diver and to a flashlight and which further includes a structure for orienting the light beam of a lighted flashlight inwardly in the direction of the line of sight and close range visual focus of a diver when underwater, yet in which the flashlight is secured to the support at a distance away from the head of a diver in order to keep the beam of the lighted flashlight from being deflected by any headgear worn by the diver.

U.S. Pat. No. 5,183,326 teaches an apparatus which holds a flashlight adjacent to the side of the head of an underwater diver in order to free the hands of the underwater diver for other purposes, while still providing underwater lighting. The apparatus is designed for releasable connection to headgear worn by underwater divers and includes an element for providing support to a flashlight. The element for providing support preferably has a specific gravity of less than about one, thereby providing floatation to the apparatus and to any article which is carried by the apparatus, as well as support and orientation to a flashlight. The support is connected to the headgear of a diver and to a flashlight by one or more straps which releasably engage and secures the flashlight to the support, and which strap also releasably engages and secures the support and the flashlight which it carries to the diver. The apparatus also includes a structure for orienting the light beam of a lit flashlight inwardly in the direction of the line of sight and close range visual focus of a diver when underwater. The flashlight is secured to the support at a distance away from the head of an underwater diver in order to keep the beam of a lighted flashlight from being deflected by any headgear worn by the underwater diver.

U.S. Pat. No. 6,116,729 teaches a modified magnifying glass with more than one clamps built on the bottom of the fixer of head magnifying glass for clamping tendons stretching out from the top of magnifying plate. A pivoting seat is set up on the top of said fixer and a revolving bracket set up on the bottom of illuminating body is pivoted at said pivoting seat. It is convenient for the users to replace magnifying plates of different magnification according to needs and magnifying glass can be turned up to vanish from user's sight while it is not in use. Besides, the angle of depression and the angle of elevation of illuminating body can be adjusted by turning the revolving bracket pivoted in the pivoting seat to allow light directly irradiates in use and practical effect are realized,

U.S. Pat. No. D-431,585 teaches the ornamental design for enhanced night vision goggle.

U.S. Pat. No. 5,777,712 teaches a diving mask which includes a supporting member arranged for sealing engagement with the face of the user and a lens which is mounted in the supporting member. The supporting member is dimensioned, so that the lens is positioned near the eyes of the user with a portion of the nose extending forwardly of the lens means to provide a low profile, low internal volume mask. The lens is substantially spherical in configuration and has a single center of curvature. The apparent magnification of images underwater is less than that observed through a conventional lens plate.

U.S. Pat. No. 4,734,834 teaches a portable lamp, especially for mounting on the head of the user, which includes an adjustment collar designed to ensure displacement of the reflector causing a variation of the light beam focus and operation of the bulb switch. The lamp comprises a single casing having an insulating body which is subdivided by an intermediate wall into a first rear compartment housing the power supply unit, and a second front compartment housing the bulb and the adjustable focusing device. The wall is provided with a communication orifice between the two adjacent compartments, and with a fixed sleeve to house the bulb. The switch is composed of an elastic contact blade cooperating with a flange of the reflector.

U.S. Pat. No. 4,429,350, U.S. Pat. No. 4,638,410, U.S. Pat. No. 4,734,834, U.S. Pat. No. 4,817,212, U.S. Pat. No. 5,053,932, U.S. Pat. No. 5,034,862, U.S. Pat. No. 4,970,631, U.S. Pat. No. 4,887,194, U.S. Pat. No. 4,797,793, U.S. Pat. No. 4,729,499, U.S. Pat. No. 4,718,126, U.S. Pat. No. 4,360,930, U.S. Pat. No. 3,249,271 and U.S. Pat. No. 4,870,550 teach relevant masks and accessories for underwater divers.

The inventor hereby incorporates all of the above-referenced patents into this specification.

### SUMMARY OF INVENTION

The present invention is generally directed to an underwater diver's combination mask and lighting assembly. The underwater diver's combination mask and lighting assembly includes a faceplate, a frame, an interface, a lighting assembly and an electrical source. The faceplate is inserted in the frame. The interface is inserted between the frame and the face of the underwater diver. The lighting assembly is mechanically coupled to the frame. The electrical source is electrically coupled to the lighting assembly.

In a first, separate aspect of the present invention, the light assembly directs the beam of light toward the line of sight of the underwater diver.

In a second, separate aspect of the present invention, the light assembly includes a plurality of diodes and a holding strip. The holding strip is mechanically coupled to frame adjacent to the top of the frame. The diodes are electrically coupled to the electrical source.

In a third, separate aspect of the present invention, the electrical source includes a plurality of batteries each of which has an output connector and a battery mount and a switching apparatus.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### DESCRIPTION OF THE DRAWINGS

FIG. 1 is a perspective drawing of an underwater diver's combination mask and lighting assembly which U.S. Pat. No. 5,767,932 teaches and which includes a face-plate, a frame, an interface and a lighting assembly

FIG. 2 is a partial side elevational view in cross-section of the underwater diver's combination mask and lighting assembly of FIG. 1.

FIG. 3 is a transverse elevational view in cross-section of an electrical source, which includes a belt, a belt loop, a battery, which has an output connector and a battery mount, an output cable, which electrically couples the output connector to the lighting assembly of FIG. 1.

FIG. 4 is a longitudinal elevational view in cross-section of an electrical source, which includes a belt, a belt loop, a plurality of batteries, each of which has an output connector, a switch which has a plurality of input connectors and an output connector, a plurality of input cables, each of which electrically couples one of the output connectors of the batteries to one of the input connectors of the switch, and an output connector, an output cable, which electrically couples the output connector of the switch to the lighting assembly of FIG. 1.

FIG. 5 is a partial perspective drawing of the electrical source of FIG. 4.

FIG. 6 is a schematic drawing of the electrical source of FIG. 4.

FIG. 7 is an exploded side view of an underwater electrical light. U.S. Pat. No. 5,070,437 teaches the underwater electrical light.

FIG. 8 is a perspective of a scuba device having a circuit for turning on a light emitting diode. U.S. Pat. No. 5,622,422 teaches the scuba device.

FIG. 9 is a perspective drawing of a diver's mask and lighting assembly according to the present invention.

### DESCRIPTION OF THE PREFERRED EMBODIMENTS

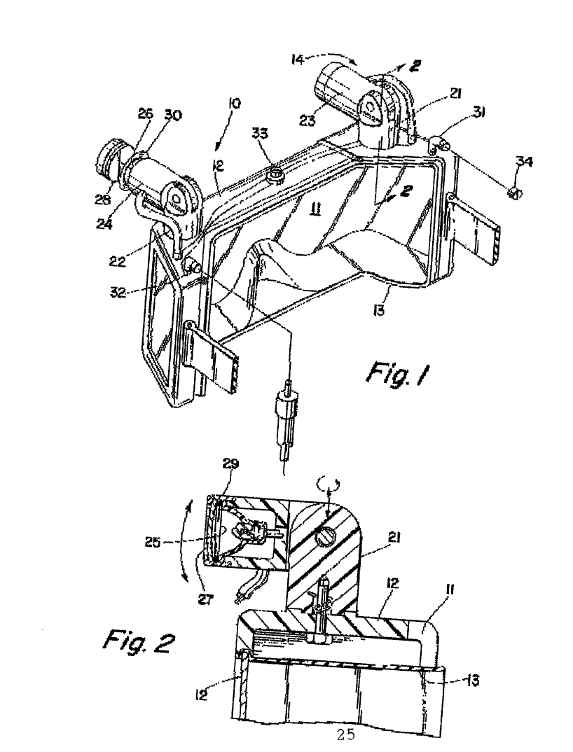

Referring to FIG. 1 in conjunction with FIG. 2 a combination driver's mask and lighting assembly 10 includes a faceplate 11, a frame 12 which has a first side and a second side, an interface 13 and a lighting assembly 14. The faceplate 11 is inserted in the frame 12. The interface 13 is inserted between the frame 12 and the face of the underwater diver and is generally formed out of a resilient material such as either plastic or rubber. The lighting assembly 14 includes a first turret 21, a second turret 22, a first light-tube 23, a second light-tube 24, a first lamp 25, a second lamp 26, a first lens 27, a second lens 28, a first O-ring 29 and a second O-ring 30. The first and second turrets 21 and 22 are rotatably coupled to the frame 12 adjacent to the first and second sides thereof, respectively. The first and second light-tubes 23 and 24 are pivotally coupled to the first and second turret at their first ends, respectively. The first and second light-tubes 23 and 24 have a cavity and an inner circumferencial groove at their second ends. The first and second lamps are disposed in the cavity of the first and second light-tubes 23 and 24, respectively. The first and second lenses 27 and 28 are disposed in the cavity of the first and second light-tubes 23 and 24 adjacent to the inner circumferencial groove thereof. The first and second O-rings 29 and 30 are disposed in the inner circumferencial groove thereof. The lighting assembly 14 also includes a first input connector 31, a second input connector 32 and a switch 33 which has an off-position, a first on-position and a second on-position. A cap 34 covers either the first input connector 31 or the second input connector 32. The switch 33 electrically couples either the first input connector 31 or the second input connector 32 to the first and second lamps 25 and 26.

Referring to FIG. 3 an electrical source 40 includes a belt 41, a belt loop 42, a battery 43, which has an output connector 44 and a battery mount 45 which mechanically couples the battery 43 to the belt loop 42, and an output cable 46. The output cable 46 electrically couples the output connector 44 of the battery 43 to either the first input connector 31 or the second input connector 32 of the lighting assembly 14.

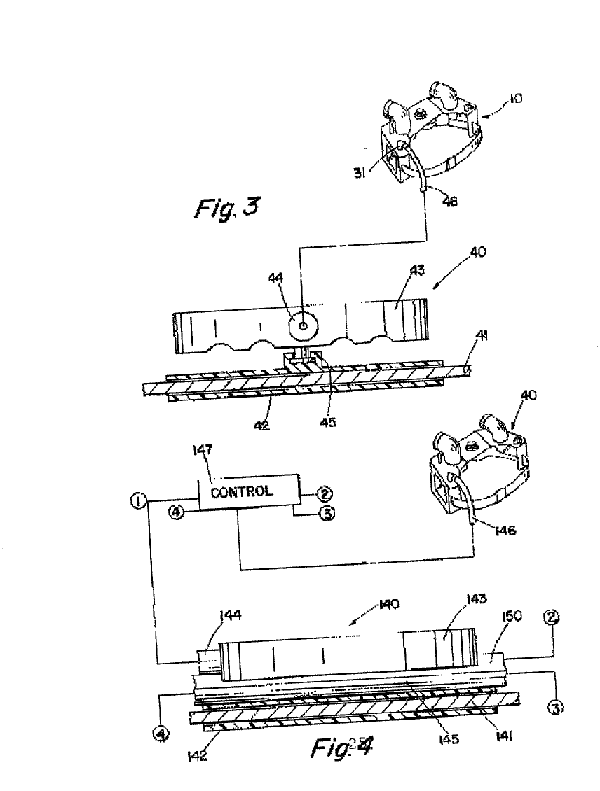

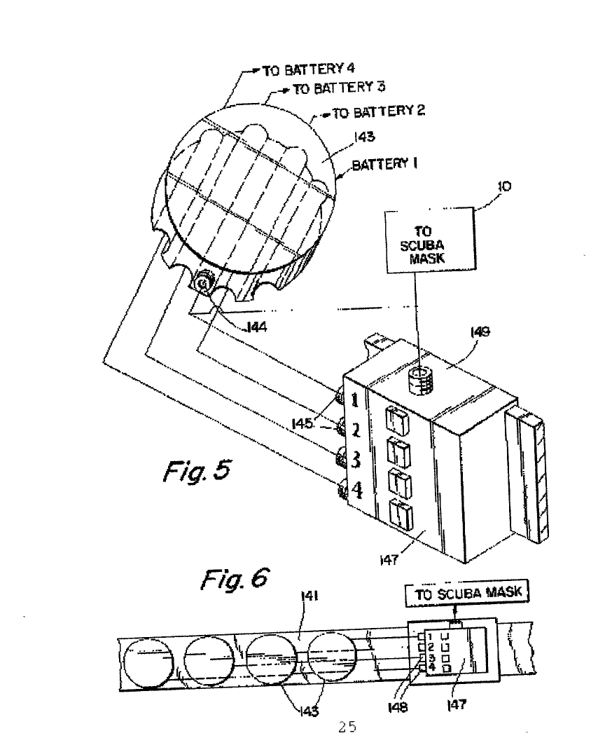

Referring to FIG. 4 in conjunction with FIG. 5 and FIG. 6 an electrical source 140 includes a belt 141, a plurality of belt loops 142 and a plurality of batteries 143. Each battery 143 has an output connector 144 and a battery mount 145. Each battery mount 145 mechanically couples one of the batteries 143 to one of the belt loops 142. The electrical source 140 also includes an output cable 146, a switching connector 147 which has a plurality of input connectors 148 and an output connector 149 and a plurality of input cables 150. Each input cable 150 electrically couples the output connector 144 of one of the batteries 143 to one of the input connectors 148 of the switch 147. The output cable 146 electrically couples the output connector 149 of the switching connector 147 to either the first input connector 31 or the second input connector 32 of the lighting assembly 14.

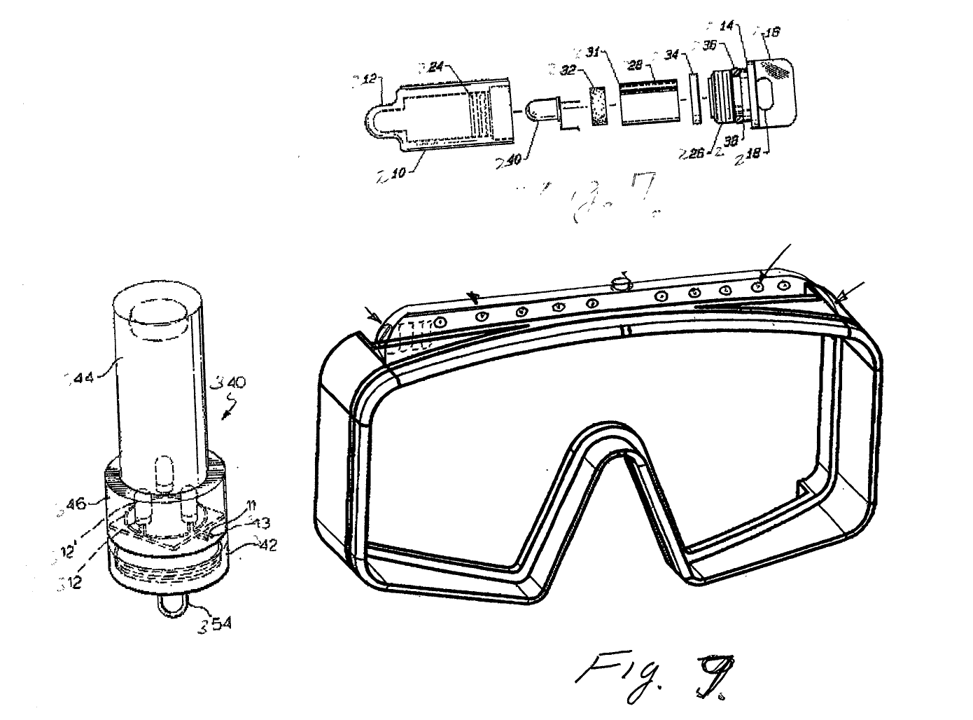

Referring to FIG. 7 a submersible light includes a generally cylindrical housing body having a closed end and an open end. A light emitting diode and a plurality of batteries are provided in the body and an end cap for the open end actuates the light by flexing a lead of the light emitting diode into engagement with the batteries. A clamp ring is provided on the outside of the cylindrical housing body under which a line can slip for snap-on attachment of the light to a fishing line and the like. An electrical light includes a body portion 210 having a closed end 212. The body portion 210 accommodates a light such as a light emitting diode. A removable cap 214 threadably engages the opposite end of the housing body 210 and provides a water tight seal for the light and battery power source within the body 210. The end of cap 214 includes a flange or handle 216 having a slot 218 for fastening the light to a fishing line, life preserver, or other object. The housing and cap preferably include an injection moldable material such as acrylic with the outside surface being highly polished. Preferably the inside surface of the body 210 other than the end 212 is provided with a textured surface. The housing body 210 is generally cylindrical with a rib 220 on the exterior surface running the length of the body. A segmented ring 222 is positionable about the housing body and is rotatable thereon. The ends of the ring facing the rib 220 have inclined surfaces. The inclined surfaces allow a fishing line to slip under the ring for locking a fishing line to the body. The housing 210 includes an internally threaded surface 224. The internally threaded surface 224 receives threads 226 on the cap 214. A sleeve 228 fits within the housing 210 and provides support for a plurality of button batteries. A groove 231 runs the length of the outer surface of the sleeve 228 and accommodates one lead of a light emitting diode. A foam rubber disk 232 is provided at one end of the sleeve 228 and a hard rubber disk 234 is provided at the opposing end of the sleeve 228. An O-ring 236 is provided in a groove 238 of the cap and provides a watertight seal with the housing 210 when the cap threadably engages the body 210.

Referring to FIG. 8 an assembly having a body 340 and a capsule 42. The body 340 is formed in a smaller diameter cylinder 344 and a wider diameter cylinder 346 arranged end to end preferably a single piece of molded plastic, encapsulating the circuitry, timer, switch, battery and light emitting diodes. The circuitry is completely encapsulated and protected from the water except for the optional alternative of providing a pair of exposed probes 311 and 313 (connected to the circuitry) for sensing the presence or absence of Water surrounding the assembly. The body may be transparent so that the light may be transmitted from the encapsulated light emitting diode to the body's exterior but it is preferably translucent so that the translucent plastic can either spread or diffuse the light emitted by the light emitting diodes in order to either illuminate the surroundings or indicate the position of a swimmer to others. The body 340 has a specific gravity somewhat greater than water. Hence the body 340 is provided with an enclosed void or bubble 43 to ensure its buoyancy. If desired the buoyancy of the body is made large enough to render either the assembly of body and capsules, or the body alone, buoyant. Such buoyancy reduces the risk of loss of the assembly or body, respectively, since detachment from the swimmer will cause it to rise to the surface. The buoyancy of the body also may cause the flashing body on the water surface to indicate the presence of the swimmer. The capsule is a shallow, open-topped cylinder which is adapted to be attached to the lower portion of the wider cylinder 346 of the body. The attachment is preferably achieved by a friction fit between the inner cylindrical surface of the capsule and the outer cylindrical surface of the body 340. However complementary screw threading or other releasable body-capsule attachment means for the capsule may be used. The body 340 and capsule are designed so that, when assembled together, there is a space in the capsule. In this capsule space a coil of mono-filament plastic line 350 is located in the space and the line is tethered at one end to the capsule and at the other end to the body at 352.

Referring to FIG. 9 a combination underwater diver's mask and lighting assembly 410 includes a face-plate 411, a frame 412 in which the face-plate 411 is inserted, an interface 413 and an electrical source 414, such as flat batteries. The frame has a top, a first side and a second side. The interface 413 is inserted between the frame 412 and the face of the underwater diver. The combination underwater diver's mask and lighting assembly 410 also includes a lighting assembly 420 which is mechanically coupled to the frame. The lighting assembly 420 includes a plurality of light emitting diodes 421 and a mounting strip 422 to which each of the light emitting diodes 421 is mechanically coupled. The mounting strip 422 is mechanically coupled to he top of the frame 412. A three position (off, low and high switch 423 electrically couples the electrical source 414 to the diodes 421 of the lighting assembly 420.

From the foregoing it can be seen that a combination underwater diver's mask and lighting assembly has been described. It should be noted that the sketches are not drawn to scale and that distances of and between the figures are not to be considered significant.

Accordingly it is intended that the foregoing disclosure and showing made in the drawing shall be considered only as an illustration of the principle of the present invention.

What is claimed is:

1. A combination underwater diver's mask and lighting assembly comprising:
a. a faceplate;
b. a frame in which said face-plate is inserted, said frame having a top, a first side and a second side;
c. a lighting assembly mechanically coupled to said frame wherein said lighting assembly includes:
i. a plurality of light emitting diodes; and
ii. a mounting strip to which each of light emitting diodes is mechanically coupled wherein said mounting strip is mechanically coupled to said top of said frame; and
d. an electrical source electrically coupled to said emitting diodes of said lighting assembly.
